(19) United States
(12) Patent Application Publication
(10) Pub. No.: US 2006/0026218 A1
(43) Pub. Date: Feb. 2, 2006

(54) Tracking objects modified between backup operations

(75) Inventor: Richard Urmston, Westborough, MA (US)

Correspondence Address: VAN PELT, YI & JAMES LLP, 10050 N. FOOTHILL BLVD #200, CUPERTINO, CA, 95014, US

(73) Assignee: EMC Corporation

(21) Appl. No.: 11/188,222

(22) Filed: Jul. 22, 2005

Related U.S. Application Data
(60) Provisional application No. 60/590,594, filed on Jul. 23, 2004.

(51) Int. Cl. G06F 17/30

(52) U.S. Cl. 707/204

(57) ABSTRACT

A method of tracking changes to stored data is disclosed. The method comprises receiving, subsequent to a prior backup operation being performed, a request to write to a stored object and ensuring that an identifier associated with the stored object is included in a stored set of identifiers, wherein each identifier in the set is associated with a stored object that has been added or modified subsequent to the prior backup operation being performed. The method further comprises including the stored object in a subsequent incremental backup operation based at least in part on the presence of the identifier in the set.

### CROSS REFERENCE TO OTHER APPLICATIONS

This application claims priority to U.S. Provisional Patent Application No. 60/590,594 (Attorney Docket No. LEGAP073+) entitled FILE TRACKING FOR BACKUP filed Jul. 23, 2004, which is incorporated herein by reference for all purposes.

### BACKGROUND OF THE INVENTION

Incremental backups significantly reduce the number of files to backup by only storing files that have been modified or added since a prior incremental or full (e.g., all file) backup. Files that have been modified or added can be identified by the backup system by inspecting the file system attributes of all files covered by the backup system. The attributes can be inspected to see if the file has been modified or created since the time and date of a prior backup operation. However, the inspection of file system attributes for all files covered by the backup system can consume significant processor time and resources especially if the number of files covered by the backup system is large. It would be useful to efficiently enable incremental backups without having to inspect all files (or other stored objects) covered by the backup system.

### BRIEF DESCRIPTION OF THE DRAWINGS

Various embodiments of the invention are disclosed in the following detailed description and the accompanying drawings.

FIG. 1 illustrates an embodiment of a system for tracking object modified between backup operations.

FIG. 2 illustrates an embodiment of a system for tracking object modified between backup operations.

FIG. 3 illustrates a list of files that have been modified or added used in one embodiment as a set of identifiers wherein each identifier in the set is associated with a stored object that has been added or modified subsequent to a prior backup operation being performed.

FIG. 4 illustrates an embodiment of a process for backup software capable of tracking objects modified between backups.

FIG. 5 illustrates an embodiment of a process for initializing backup software.

FIG. 6 illustrates an embodiment of a process for selecting backup software parameters.

FIG. 7 illustrates an embodiment of a process for activating backup software.

FIG. 8 illustrates an embodiment for a process for a driver upon notification that a full backup us to be performed.

FIG. 9 illustrates an embodiment for a process for a driver monitoring file writes.

FIG. 10 illustrates an embodiment for a process for a driver upon notification that an incremental backup is to be performed.

### DETAILED DESCRIPTION

The invention can be implemented in numerous ways, including as a process, an apparatus, a system, a composition of matter, a computer readable medium such as a computer readable storage medium or a computer network wherein program instructions are sent over optical or electronic communication links. In this specification, these implementations, or any other form that the invention may take, may be referred to as techniques. A component such as a processor or a memory described as being configured to perform a task includes both a general component that is temporarily configured to perform the task at a given time or a specific component that is manufactured to perform the task. In general, the order of the steps of disclosed processes may be altered within the scope of the invention.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Tracking objects modified between backup operations is disclosed. Requests to write objects are monitored. When an object is added or changed, an identifier associated with the object is stored in a set of identifiers associated with objects that have been added or changed subsequent to a prior backup operation being performed. In a subsequent incremental backup operation, the presence of the identifier in the stored set of identifiers is used to determine, at least in part, the objects to be included in the incremental backup. In some embodiments, the identifier is added to the stored set of identifiers only if the identifier for that object is not already included in the stored set of identifiers, e.g., by virtue of having been added to the set in response to a prior request to write to the object.

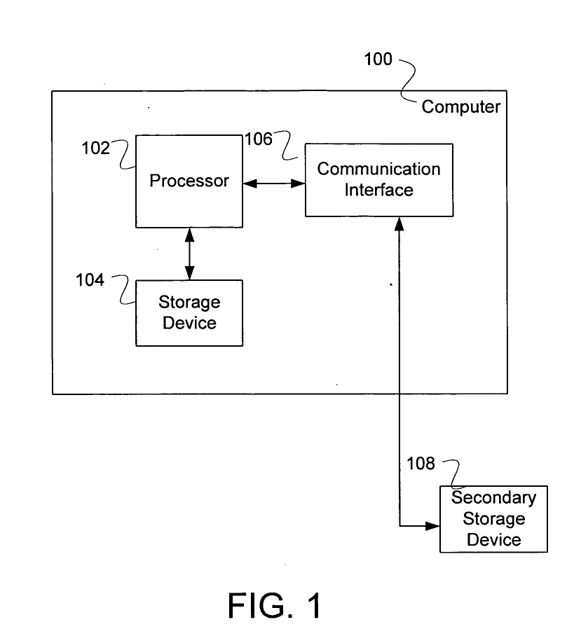

FIG. 1 illustrates an embodiment of a system for tracking objects modified between backup operations. Computer 100 includes processor 102, storage device 104, and communication interface 106. Communications interface 106 is coupled to secondary storage device 108. In various embodiments, secondary storage device 108 is coupled to a network (for example, a local area network, a wide area network, or the Internet), coupled to a computer, coupled directly to processor 102, or comprises a portion of a single storage device comprising storage device 104 and secondary storage device 108. In some embodiments, computer 100 is configured to track objects modified between backup operations. In some embodiments, processor 102 receives, subsequent to a prior backup operation being performed, a request to write to (e.g., add or update) a stored object on storage device 104 and ensures that an identifier associated with the stored object is included in a stored set of identifiers associated with stored objects that have been added or modified subsequent to the prior backup operation being performed. The stored object is included in a subsequent incremental backup operation based at least in part on the presence of the identifier in the set.

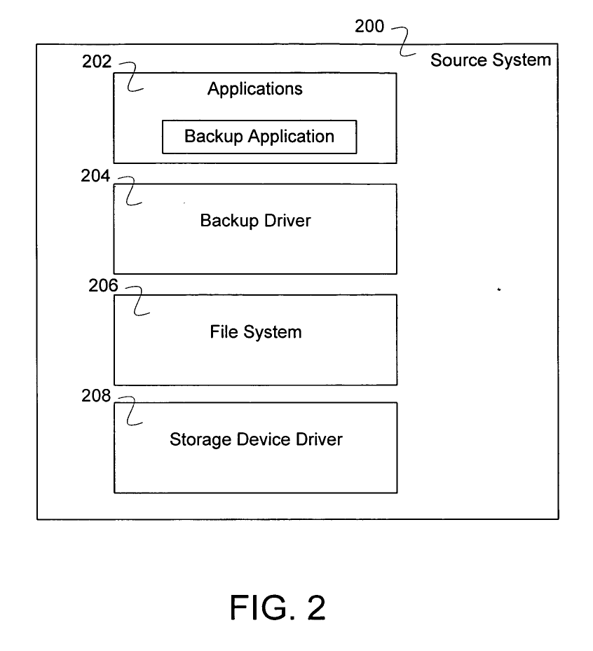

FIG. 2 illustrates an embodiment of a system for tracking objects modified between backup operations. In the example shown, source system 200 includes applications 202, backup driver 204, file system 206, and storage device driver 208. In the example shown, applications 202 include a backup application. The backup application communicates with backup driver 204. In some embodiments, the backup application is used to select data to be backed up, select the secondary storage device used to store the backed up data, select the frequency and/or times for backups, select the types of backups (e.g. incremental or full backups), and initialize backup driver 204. Backup driver 204 is designed to receive requests from applications 202 to write objects (for example, add or update a file or other stored object) to the storage device. In some embodiments, backup driver 204 monitors requests to file system 206 to write an object to a storage device and ensures an identifier associated with the object that is being written to is included in a stored set of identifiers. The backup driver 204 passes the write request to file system 206, which implements the request using storage device driver 208.

In some embodiments, backup driver 204 creates a new stored set of identifiers upon being notified that a full backup is to be performed. In some embodiments, backup driver 204 freezes a current stored set of identifiers upon being notified that an incremental backup is to be performed, creates a new stored set of identifiers, monitors file writes, provides the frozen stored set of identifiers to be used to help determine which files are to be included in an incremental backup operation, and deletes the frozen stored set of identifiers upon being notified that the incremental backup operation has been completed. The backup application is configured to use the stored set of identifiers to perform an incremental backup operation by copying to a secondary location (e.g., a local or remote storage device and/or media) only those stored objects for which an associated identifier is included in the set. By using the stored set of identifiers, the backup application is not required to check any attribute(s) of all objects in the data set to which the backup pertains, e.g. a file system or portion thereof, because the set of identifiers can be used to quickly determine which objects have been added or changed since the last full or incremental backup.

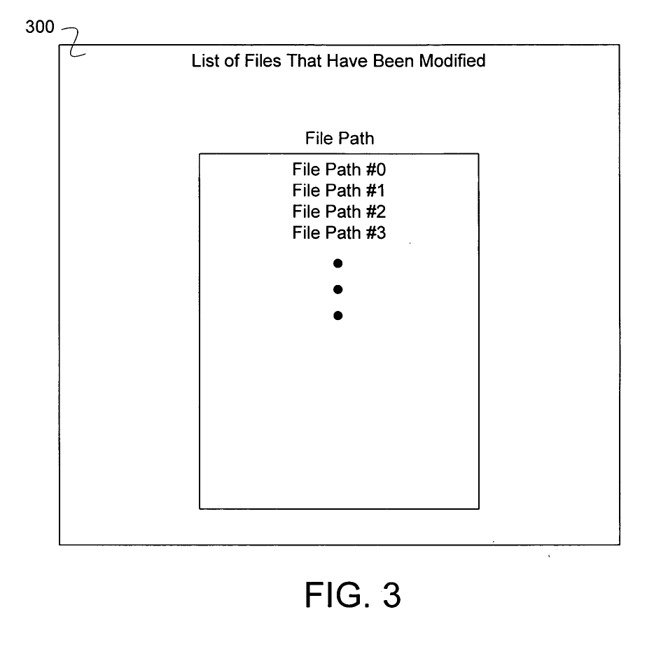

FIG. 3 illustrates a list of files that have been modified or added used in one embodiment as a set of identifiers associated with stored objects that have been added, deleted, or modified subsequent to a prior backup operation being performed. In the example shown, a list of files that have been modified 300 includes a plurality of file paths, each path representing a file that has been added or changed since the last full or incremental backup, as applicable. The plurality of file paths is represented by File Path #0, File Path #1, File Path #2, File Path #3, etc. In various embodiments, identifiers other than file paths are used to identify stored objects that have been added to or modified subsequent to a prior backup operation. In some embodiments, a data structure other than a list of identifiers is used.

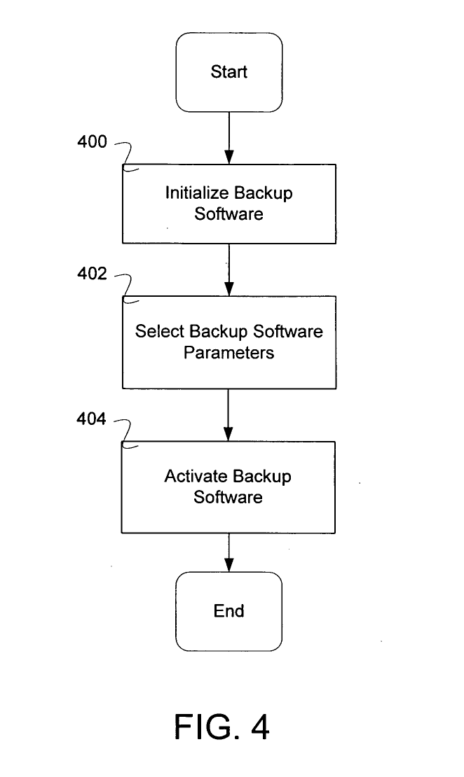

FIG. 4 illustrates an embodiment of a process for installing and configuring a backup application. In the example shown, the backup software is initialized in 400. In some embodiments, initialization includes selecting the source data for backups (i.e., defining the data set to be backed up), the secondary storage location where the backup data is to be stored, and initializing the backup driver. In 402, the backup software parameters are selected. In some embodiments, parameters include when backups occur (e.g. the frequency of backups, the time for each backup, or the events that trigger a backup) and the types of backup for each specified backup. In 404, the backup software is activated.

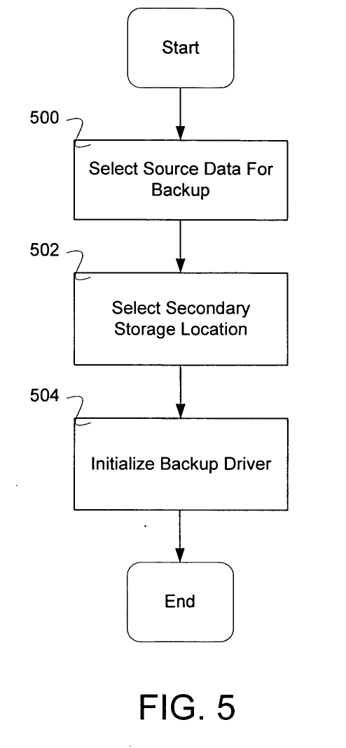

FIG. 5 illustrates an embodiment of a process for initializing backup software. In some embodiments, the process of FIG. 5 is used to implement 400 of FIG. 4. In the example shown, source data for backup is selected in 500. The source data includes the data that is desired to be included in the backups. In some embodiments, this data copied to a secondary storage device at specified times and the data can be restored to the state it was in at the specified times using the stored data on the secondary storage device. In 502, secondary storage location is selected. In various embodiments, the secondary storage location is located on a local storage device, a network attached storage device, or a remote storage device. In 504, the backup driver is initialized. In some embodiments, the backup driver is started running in the computer system during initialization.

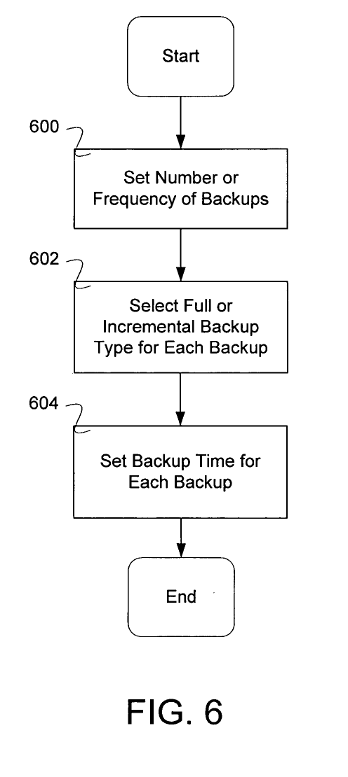

FIG. 6 illustrates an embodiment of a process for selecting backup software parameters. In some embodiments, the process of FIG. 6 is used to implement 402 of FIG. 4. In the example shown, the number or frequency of backups is set in 600. In some embodiments, events (for example, a software release date, a target amount of data being written to the storage device, or a user or administrator indication) trigger backups in addition to or instead of a regular frequency (i.e. once a week or once a month) backup. In 602, full or incremental backup type for each backup is selected. In some embodiments, a full backup is the storing of a copy of all selected source data from a source storage device to a secondary storage device at a selected time from which the source data can be restored. In some embodiments, an incremental backup is the storing of modified or new selected source data since the last incremental or full backup from a source storage device to a secondary storage device at a selected time from which, in conjunction with the prior incremental and full backups, the source data can be restored. In 604, backup time for each backup is selected.

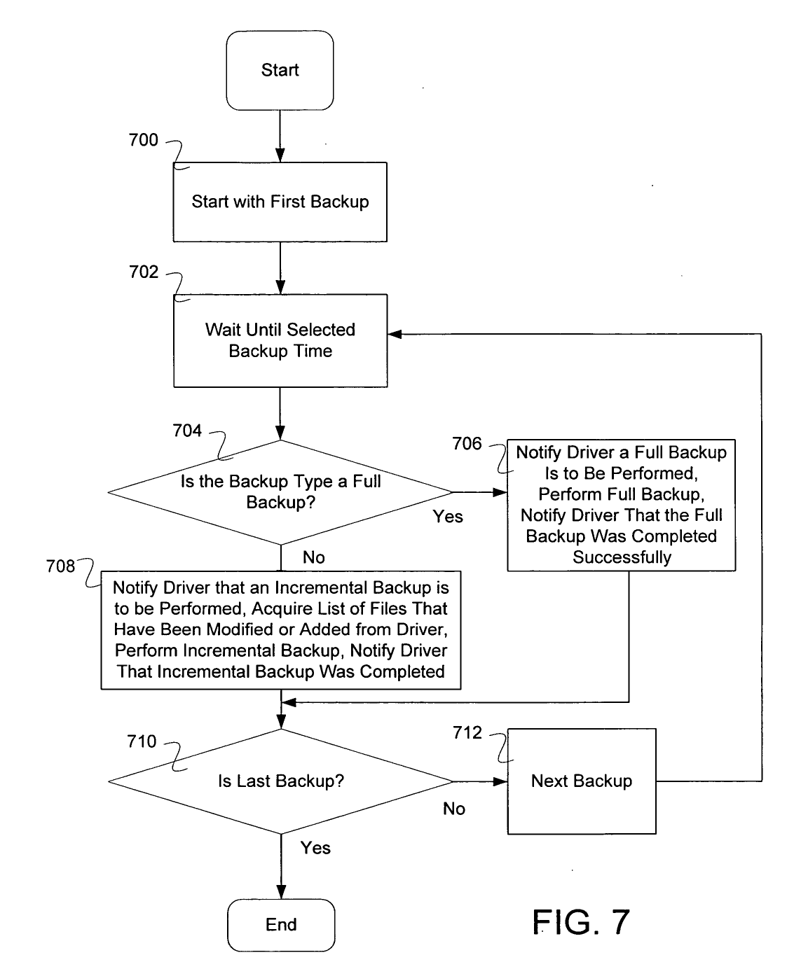

FIG. 7 illustrates an embodiment of a process for backing up data. In some embodiments, the process of FIG. 7 is used to implement 404 of FIG. 4. In the example shown, in 700 the first backup is selected to start. In 702, the backup time of the selected backup is waited for. In 704, it is determined if the backup type of the selected backup is a full backup. If the backup type is a full backup, then in 706 the driver is notified that a full backup is to be performed (e.g., so that the driver knows to freeze the list of modified objects), a full backup is performed, the driver is notified when the full backup has been completed (e.g., so the driver knows it is safe to delete the previously frozen list of modified objects), and control passes to 710. If the backup type is not a full backup, then in 708 the driver is notified that an incremental backup is to be performed (e.g., so that the driver knows to freeze the list), the list of files that have been modified or added since the last full or incremental backup is acquired, an incremental backup is performed by copying to a preconfigured secondary storage location (e.g., a tape drive, local drive, network attached storage, etc.) the files that are in the list of files that have been modified or added since the last full or incremental backup, and the backup driver is informed when the incremental backup has been completed (e.g., to let the driver know that the previously-frozen list can be purged). In 710, it is determined if the backup that has just been performed is the last backup required to be performed. If it is not the last backup, then in 712 the next backup is selected and control is passed to 702. If it is the last backup, then the process ends.

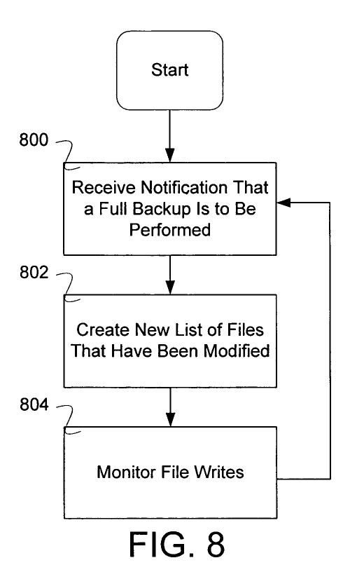

FIG. 8 illustrates an embodiment of a process for resetting a list of modified objects upon receipt of a notification that a full backup operation is to be performed. In some embodiments, the process of FIG. 8 is implemented by a driver such as backup driver 204 of FIG. 2. In the example shown, notification that a full backup is to be performed is received in 800. In 802, a new list of files that have been modified or added is created. In some embodiments, the new list of files that have been modified or added comprises a set of identifiers wherein each identifier in the set is associated with a stored object that has been added or modified subsequent to a prior backup operation being performed. In some embodiments, 802 includes freezing the previously maintained list of files (or other objects) that have been modified. In some embodiments, the previously frozen list is purged upon receipt of an indication that the full backup operation the initiation of which resulted in the previously maintained list being frozen has been completed successfully. In 804, file writes are monitored and an identifier is added to the new list created in 802 the first time an object is added or changed subsequent to the new list being created. In some embodiments, writes other than file writes (e.g. object writes) are monitored.

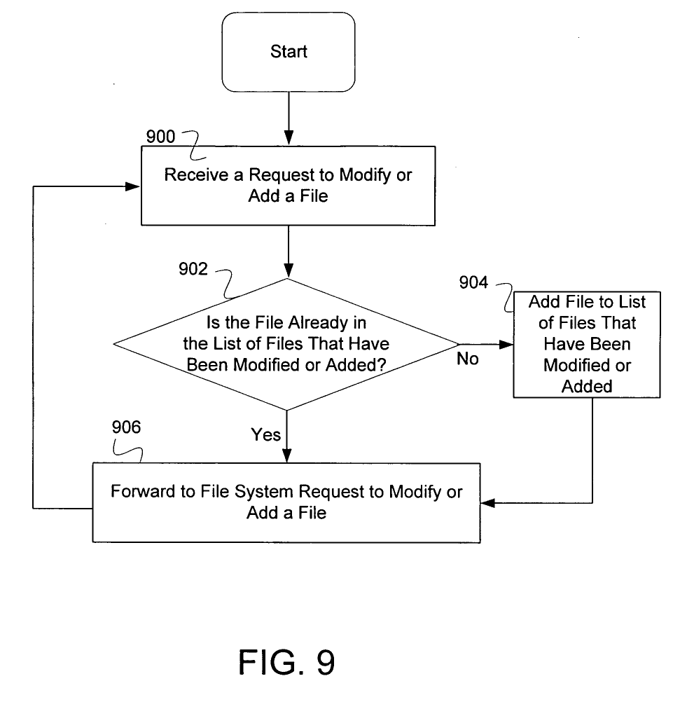

FIG. 9 illustrates an embodiment of a process for monitoring file writes. In some embodiments, the process of FIG. 9 is used to implement 804 of FIG. 8. In some embodiments, the process of FIG. 9 is implemented by a driver such as backup driver 204 of FIG. 2. In the example shown, at 900 a request to modify or add a file is received. In 902, it is determined if the file is already in the list of files that have been modified or added. If the file is not already in the list of files that have been modified or added, then in 904 the file is added to the list of files that have been modified or added, after which the request is forwarded to the file system at 906 and control returns to 900, in which the next request to modify or add a file, if any, is received. If the file is already in the list, then control passes directly to 906 and continues as described. In some embodiments, there is no check to see if the file is already in the list of files that have been modified or added, the file is simply added to the list upon receiving the request to add or modify a file. In some embodiments, a memory cache and a data hashing algorithm are used to efficiently track the files that have been modified or added. In some embodiments, when a new file is added to the cached list of files that have been modified or added, the list is written to persistent memory (e.g. a hard disk or other permanent storage device).

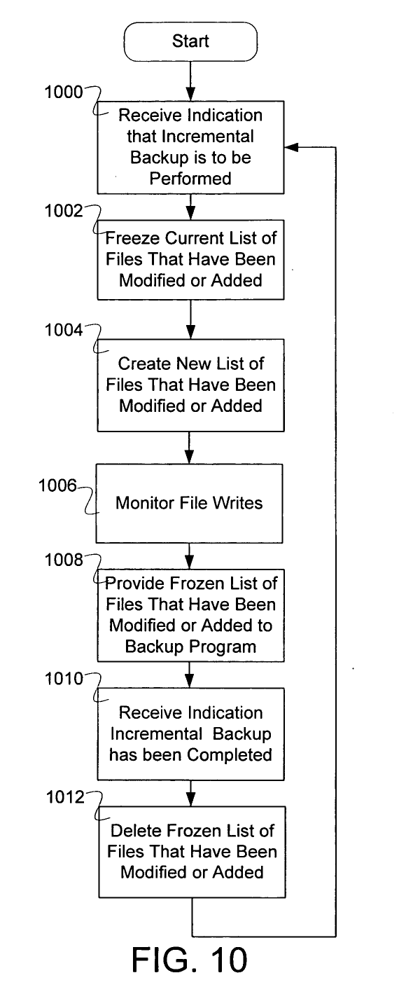

FIG. 10 illustrates an embodiment for a process for freezing, resetting, and purging a modified object list when an incremental backup is performed. In some embodiments, the process of FIG. 9 is implemented by a driver such as backup driver 204 of FIG. 2. In the example shown, in 1000 an indication that an incremental backup is to be performed is received. In 1002, the current list of files that have been modified or added is frozen. In 1004, a new list of files that have been modified or added is created. In 1006, file writes are monitored and any file added or changed subsequent to the new list being created is added to the new list. In some embodiments, the process of FIG. 9 is used to implement 1006. In 1008, the frozen list of files that have been modified or added is provided to the backup program. In some embodiments, the frozen list of files is used by the backup program to determine the files that are to be included in the incremental backup. In 1010, an indication that the incremental backup has been completed is received. In 1012, the list of files frozen in 1002 is deleted.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method of tracking changes to stored data comprising:
receiving, subsequent to a prior backup operation being performed, a request to add or change a stored object;
storing an identifier associated with the stored object; and
including the stored object in a subsequent incremental backup operation based at least in part on the stored identifier.

2. A method as in claim 1, wherein storing an identifier associated with the stored object includes ensuring that the identifier is included in a stored set of identifiers associated with stored objects that have been added or changed since the prior backup operation.

3. A method as in claim 2, wherein ensuring that the identifier is included in a stored set of identifiers associated with stored objects that have been added or changed since the prior backup operation includes:
determining whether the identifier associated with the stored object is included already in the stored set of identifiers; and
adding the stored identifier to the stored set of identifiers if it is determined the stored identifier is not already included in the stored set of identifiers.

4. A method as in claim 2, wherein the stored set of identifiers comprises a list of identifiers.

5. A method as in claim 2, wherein the stored set of identifiers comprises a list of files that have been changed subsequent to the prior backup operation.

6. A method as in claim 2, further comprising:
receiving an indication that an initiated incremental backup operation is to be performed;
freezing the stored set of identifiers; and
initializing a new stored set of identifiers to be used to store identifiers associated with store objects, if any, that are added or modified subsequent to receipt of the indication that the initiated incremental backup operation is to be performed.

7. A method as in claim 2, wherein a new stored set of identifiers is created before starting an incremental backup.

8. A method as in claim 2, wherein the stored set of identifiers is deleted after completing an incremental backup.

9. A method as in claim 1, wherein the request to write to the stored object is received by a driver associated with a backup application.

10. A method as in claim 1, wherein the stored object comprises a file.

11. A method as in claim 1, wherein the prior backup operation comprises a full backup operation.

12. A method as in claim 1, wherein the prior backup operation comprises a prior incremental backup operation.

13. A system for tracking changes to stored data comprising:
a processor configured to
receive, subsequent to a prior backup operation being performed, a request to write to a stored object;
store an identifier associated with the stored object; and
include the stored object in a subsequent incremental backup operation based at least in part on the stored identifier; and
a memory coupled to the processor and configured to provide instructions to the processor.

14. A system as in claim 13, wherein the processor is configured to store the identifier by adding the identifier to a list.

15. A system as in claim 13, wherein the processor is configured to store the identifier by adding the identifier to a list if it is not already included in the list.

16. A system as in claim 13, wherein the stored object comprises a file.

17. A system as in claim 13, wherein the identifier is stored in a stored set of identifiers and the processor is further configured to:
receive an indication that an initiated incremental backup operation is to be performed;
freeze the stored set of identifiers; and
initialize a new stored set of identifiers to be used to store identifiers associated with store objects, if any, that are added or modified subsequent to receipt of the indication that the initiated incremental backup operation is to be performed.

18. A computer program product for tracking changes to stored data, the computer program product being embodied in a computer readable medium and comprising computer instructions for:
receiving, subsequent to a prior backup operation being performed, a request to write to a stored object;
storing an identifier associated with the stored object; and
including the stored object in a subsequent incremental backup operation based at least in part on the presence of the identifier in the set.

19. A computer program product as recited in claim 18, wherein ensuring that an identifier associated with the stored object is included in a stored set of identifiers includes:
determining whether the identifier associated with the stored object is included already in the stored set of identifiers; and
adding the stored identifier to the stored set of identifiers if it is determined the stored identifier is not already included in the stored set of identifiers.

20. A computer program product as recited in claim 18, wherein the stored set of identifiers comprises a list of files that have been changed subsequent to the prior backup operation.
